(19) United States
(12) Patent Application Publication
(10) Pub. No.: US 2007/0074354 A1
(43) Pub. Date: Apr. 5, 2007

(54) Method and apparatus for uniform application of treatment agents to a textile rope

(75) Inventor: Maximilian Hirsch, Michelbach/Bilz (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: THEN Maschinen GmbH, Schwabisch Hall (DE)

(21) Appl. No.: 11/445,822

(22) Filed: Jun. 2, 2006

(30) Foreign Application Priority Data
Jun. 11, 2005 (DE) 10 2005 027 070.0

(51) Int. Cl. B08B 3/12; D06B 11/00; D06B 19/00

(52) U.S. Cl. 8/149; 8/149.1; 68/5 D

(57) ABSTRACT

In a method for uniform application of treatment agents to a textile rope in a dyeing machine, the endless rope is made to revolve in a closed tank by means of a Venturi feed nozzle subjected to a gaseous feeder medium, and is thus exposed to the action of a liquid treatment agent. The treatment agent is stored, without contact with the rope, in a chamber that is separate from the rope and is made to act on the rope, without mixing with treatment agent draining from the rope, with a quantity of treatment agent per unit of time that is controlled as a function of time.

The invention relates to a method and an apparatus for uniformly applying treatment agents to a textile rope in a dyeing machine.

Jet piece dyeing machines have a closed tank and a feed nozzle system, by which, optionally reinforced by an externally driven winch, an endless rope in the tank is made to revolve in a predetermined direction of revolution. For driving the rope, the feed nozzle is acted upon by a stream of feeder medium which in machines that operate on the aerodynamic principle is a gas, air, or steam flow or a mixed steam and air flow. In this type of dyeing machines, treatment liquor in the region of the feed nozzle is made to act on the endless rope traveling through. The excess treatment liquor draining off is caught in the tank and recirculated by means of a liquor recirculation pump.

In all the aforementioned dyeing machines, treatment agents (chemicals and/or dyes) to be applied to the goods are first placed in a preparation vessel located outside the dyeing machine and optionally mixed there and, if necessary, brought to a defined temperature and then introduced by means of an additional agent pump into the liquor cycle of the dyeing machine. The treatment agents are typically added in metered fashion; that is, at a certain time during the course of wet treatment, the quantity of treatment agent contained in the preparation tank is injected, preferably finely atomized in the region of the feed nozzle, and applied to the rope.

If the course of treatment is looked at more precisely, it can be demonstrated that the concentration of treatment agent on the rope increases from one revolution to another of the rope, yet at the same time the concentration of treatment agent is lower at the beginning of the rope than at the end of the rope. If the treatment agent is added in metered fashion, for instance over five revolutions of the rope, then in the fifth revolution of the rope, there may even be a higher concentration of treatment agent at the end of the rope than would correspond to an equilibrium concentration that would be established. The equilibrium concentration is then not reached until after a few more revolutions of the rope.

For treating a rope with treatment agents, and in particular for dyeing, however, it is an important prerequisite that the most uniform possible distribution of treatment agent or dye be made over the entire length of the rope. Only then can the most uniform possible dyeing or in other words equal dyeing be expected.

In earlier, unpublished German Patent Application No. 103 49 377.8, filed Oct. 21, 2003, a method has therefore been disclosed which generates a largely uniform distribution of treatment agent over the rope set into revolution in a wet treatment machine.

In this method, the endless rope is set into revolution in a closed tank by means of a Venturi feed nozzle which is acted upon by a gaseous feeder medium. The revolving motion of the rope is maintained only by means of the gaseous feeder medium, and not by a liquor. At first, the treatment agent is stored, without touching the rope, in a separate chamber from the rope, which is for instance a chamber located below the stored rope that forms a treatment agent sump in the tank. All the chemicals, dyes, and so forth required are placed in this sump in the tank. The liquid treatment agent contained in this chamber, in other words the treatment liquor, can, for instance via suitable switching of the treatment agent injection cycle, be brought to a predetermined temperature and thoroughly mixed without coming into contact with the goods. However, the chamber may also be provided outside the tank, for instance in its vessel.

In the next treatment step, the treatment agent, in the form of the fresh treatment liquor, is applied to the moving rope with a quantity of treatment agent per unit of time that is controlled as a function of time, in such a way that essentially uniform distribution of the treatment agent over the rope is achieved.

Applying the treatment agent to the rope may be done over one or more revolutions of the rope. By means of suitable smart control of the treatment agent injection into the feed nozzle, upstream of the feed nozzle and/or downstream of the feed nozzle in terms of the goods travel direction, a uniform application of treatment agent over the length of the rope can be attained with only a few revolutions of the goods (approximately 2 to 3 revolutions), or even in only a single revolution.

The course over time of the treatment agent application during the various revolutions of the rope can be calculated in advance in a computer model, in that case, the application of treatment agent to the rope is done in a controlled way in accordance with this computer model. The calculation in advance of the application of treatment agent to the rope by the computer model is done on the basis of goods-specific, construction-specific, and treatment-specific data on the rope and/or the feed nozzle and the action of the feeder medium. These data may be input by the machine operator into the computer programmed with the computer model or picked up automatically at the machine by means of suitable sensors. The program of the computer, with knowledge of the applicable parameters and of the computer model, automatically calculates a time-dependent application of the treatment agent to the moving rope that achieves optimal distribution of the treatment agent over the length of the rope in as few revolutions of the rope as possible.

The advantages of this method are that on the one hand, faster and more uniform distribution of the treatment agent to the entire rope is achieved, and thus the prerequisite for equal dyeing is created. Second, the treatment time is shortened considerably, since the application of treatment agent is done over substantially fewer revolutions of the rope than is the case in the known methods described at the outset.

The object of the present invention is to refine the described method of the aforementioned earlier patent application.

For this purpose, the method of the invention has the characteristics of claim 1. A novel apparatus for performing this method is the subject of claim 13.

In the novel method, the treatment agent is withdrawn solely from the separate chamber and is applied to the rope without mixing with the treatment agent that is draining from the rope.

It is thus assured that the treatment agent on being applied to the rope is always at the same concentration. The treatment agent draining from the rope is carried separately from and not mixed with the treatment agent that is delivered to the feed nozzle. Performing the method is thus substantially simplified, since there is no longer a necessity to compensate for the change in concentration of the treatment agent coming to act on the revolving rope during the treatment period, for instance by means of a suitable variation of the volumetric flow of treatment agent delivered or of the speed of revolution of the rope. This kind of compensation for the influence of the variation in concentration of the treatment agent that comes to act on the rope, by way of a control algorithm for determining the rpm of the feed pump and hence of the volumetric flow pumped, is in fact not simple, since such an algorithm includes a number of variables that in practice are not readily known (such as water absorption by the textile product, water retention capacity of the textile product, capacity of exchanging fresh treatment agent for the recirculated, old treatment agent inside the feed nozzle, and so forth). Since these parameters are without influence in the novel method, which always uses treatment agent at the same concentration, the novel method is also safe and reliable when used in practice.

Refinements of the invention are the subject of dependent claims and will become apparent from the ensuing description of an exemplary embodiment of the method of the invention, which is shown in the accompanying drawings. In the drawings, in each case schematically, the following are shown:

FIG. 1, a piece dyeing machine on the aerodynamic principle, in a schematic cross-sectional view showing the status upon preparation of the treatment agent in the preparation tank of the dyeing machine;

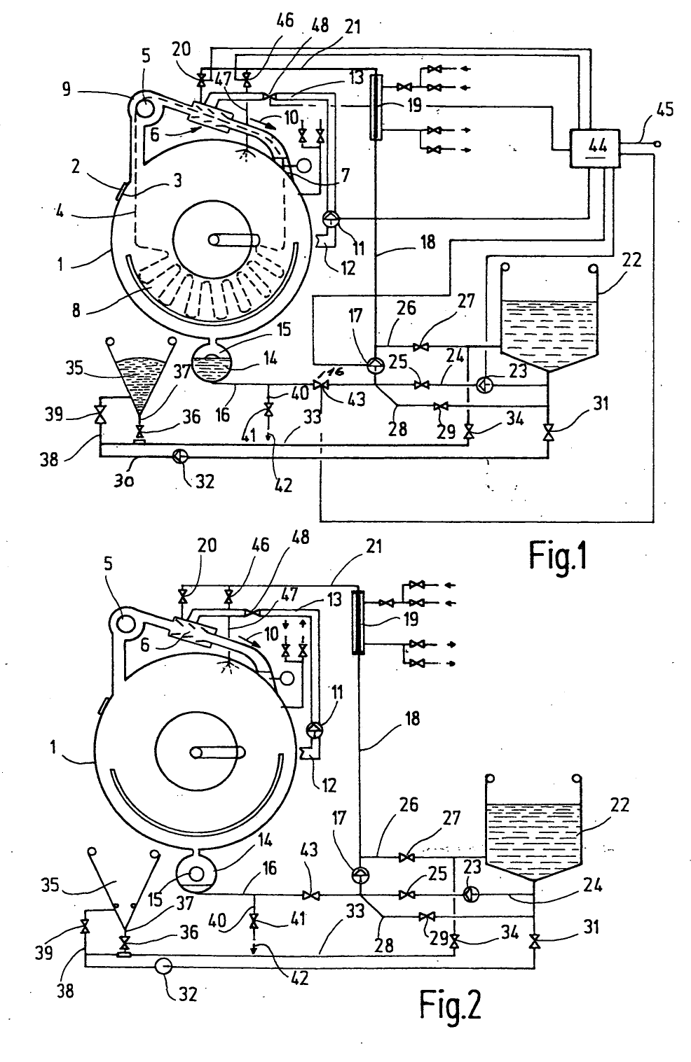

FIG. 2, the piece dyeing machine of FIG. 1 in a corresponding simplified view, showing the status as the treatment agent is being drained from the treatment tank;

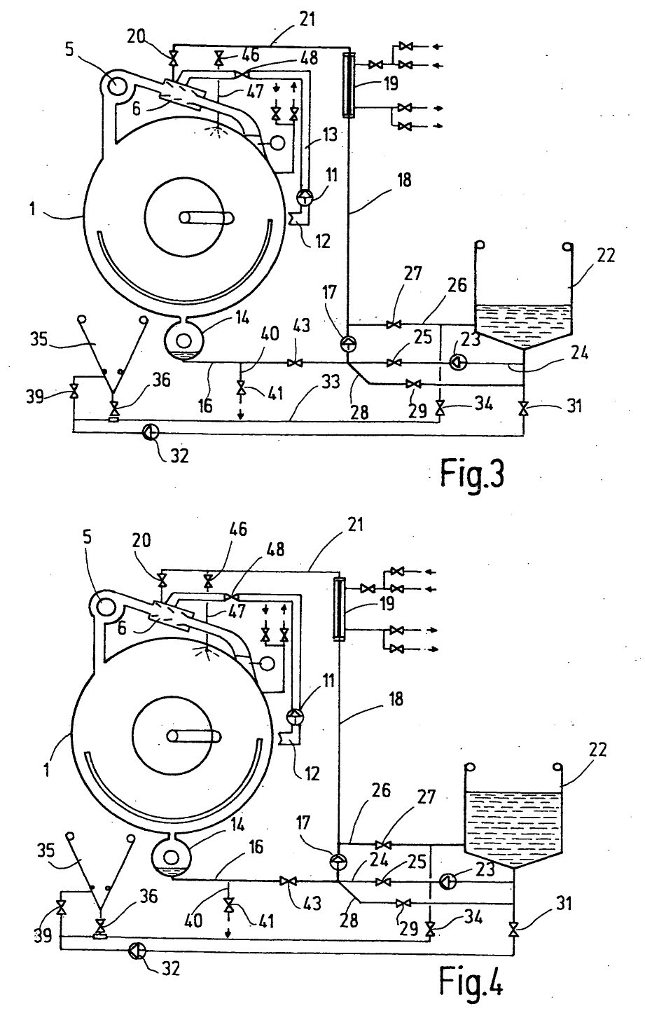

FIG. 3, the piece dyeing machine of FIG. 1 in a corresponding simplified view, showing the status upon injection of the treatment agent into the Venturi feed nozzle; and

FIG. 4, the piece dyeing machine of FIG. 1 in a corresponding simplified view, showing the addition of additional agent to the treatment agent.

The high-temperature (HT) piece dyeing machine shown schematically in FIGS. 1 through 4 has a pressureproof cylindrical tank 1, leading into which is a service opening 3 which can be closed by a lid 2 and through which a textile rope 4, represented only by dashed lines in FIG. 1, can be introduced. The rope 4 is introduced via an externally driven winch 5 into a Venturi feed nozzle 6, which is adjoined by a cuttler 7. The cuttler 7 lays the rope 4, emerging from the feed nozzle 6, in flat-folded or cuttled fashion in a reservoir 8, from which the endless rope is pulled back out again by the winch 5. The winch 5 and the feed nozzle 6 are accommodated in housing parts 9 that are joined to the tank 1 in liquid-tight fashion. After being introduced through the service opening 3, the rope 4 has been joined at its ends to form an endless loop of goods.

The feed nozzle 6 is acted upon by a gaseous stream of feeder medium, which sets the rope 4 traveling through it into revolution in a direction indicated by an arrow 10. The feeder medium in the present case is air or a steam-air mixture, which is aspirated from the tank 1 by a blower 11 and a suction line 12 and is pumped into the feed nozzle 6 via a pressure line 13.

A liquor sump 14 is located at the bottom of the tank 1 and contains a liquor filter 15. The liquor sump 14 communicates with a suction line 16 of a liquor recirculation pump 17, whose pressure line 18 includes a heat exchanger 19 and discharges into the feed nozzle 6 via a regulating valve 20. The liquor recirculation pump 17 allows the liquor, aspirated from the tank 1 via its liquor sump 14, to circulate via the feed nozzle 6 and the tank 1. A bypass line, not shown, may be located parallel to the heat exchanger 19 and the liquor recirculation pump 17; it contains a shutoff valve and connects the sump 14 with the pressure line 21 that adjoins the heat exchanger.

A preparation tank 22 is also provided, which contains a chemical treatment agent (chemicals, dyes) in the form of an aqueous solution, emulsion or dispersion that can be fed into the suction line 16 of the liquor recirculation pump 17 via a treatment agent pump 23 and a connecting line 24.

In the connecting line 24, there is a shutoff valve 25, while parallel to the connecting line 24, a line 26 is provided, which discharges into the pressure line 18 of the liquor recirculation pump and contains a shutoff valve 27 and leads directly into the preparation tank 22. A second connecting line 28, which contains a shutoff valve 29, connects the suction line 16 of the liquor recirculation pump 17 with an outflow line 30 of the preparation tank 22, in which line there are a shutoff valve 31 and a treatment agent feed pump 32, and which line is in communication, on the pressure side of the treatment agent feed pump 32, with a return line 33 that contains a shutoff valve 34 and leads back into the preparation tank 22. Communicating with the return line 33 is an additional agent tank 35, on the one hand via an outflow line 37 containing a shutoff valve 36 and on the other via a rinsing or supply line 38, which contains a shutoff valve 39. The additional agent tank 35 may contain a suitable additional agent, such as table salt, for the purpose of the particular treatment step; this additional agent can be dissolved in the tank by introducing liquid, in particular water, via the treatment agent feed pump 32 and the line 38 into the additional agent tank 35 at a certain level above the outflow line 37, and the additional agent dissolved in it is then rinsed out via the outflow line 37 and returned to the preparation tank 22 via the return line 33.

From the suction line 16 of the recirculating pump 17, a drain line 40 branches off, which contains a shutoff valve 41 that makes it possible to drain treatment agent out of the tank 1 or the sump 14, as is indicated by an arrow 42. Finally, the suction line 16 of the recirculating pump 17 also contains a shutoff valve 43, which makes it possible to separate the suction side of the liquor recirculation pump 17 in terms of liquid completely from the tank 1 and the sump 14.

The various valves and pumps are triggerable by program, using a computer represented at 44. The control connections to the most important valves and pumps are represented by fine lines in FIG. 1. A manual input of instructions and information into the computer 44 is possible at 45.

For the sake of simplicity, the computer 44 and its associated control lines have been left out of FIGS. 2 through 3.

The piece dyeing machine described thus far, operating on the aerodynamic principle, is operated according to the invention as follows for the uniform application of treatment agents to the revolving textile rope 4:

In FIG. 1, a typical operating state of the piece dyeing machine is shown schematically. The valves 25, 27, 29 and 41 are closed. The treatment agent pump 23 is off, and thus the preparation tank 22 is hydraulically completely separated from the actual machine itself, or in other words the tank 1. In a first method step, all the treatment agent, or in other words the complete treatment liquor, is prepared outside the machine, in the preparation tank 22. In the process, additional agent, such as salt, from the additional agent tank 35 can be introduced into the preparation tank 22 and dissolved. The line connections required for this purpose are shown as heavy lines in FIG. 1. The dissolved additional agent is pumped into the preparation tank 22 by the feed pump 32 via the lines 30, 33, 37 and 38 with the valves 31, 34, 36, 39 open.

This preparation of the treatment liquor can be done chronologically parallel to the operation of the piece dyeing machine and independently of it; that is, the piece dyeing machine itself is still operating in a different treatment step, in which the revolving rope 4 is being treated with a treatment liquor that is present in the tank 1 and is made to circulate via the lines 16, 18, 21, with the valves 43, 20 open, by means of the recirculating pump 17 via the feed nozzle 6 and the tank 1.

At the beginning of a second treatment step, shown in FIG. 2, the additional agent contained in the additional agent tank 35 has dissolved and is added in its entirety to the additional agent contained in the preparation tank 22. The valves 25, 27, 29, 31, 34 are closed. The treatment agent pump 23 is at a stop, and the recirculating pump 17 is off. The valves 41, 43 are opened, causing all the treatment liquor originating in the previous treatment step to be drained from the tank 1 via the drain line 40; thus at the end of this treatment step, the tank 1 has been completely emptied.

In a third method step, which is shown in FIG. 3, the valves 25, 27, 31, 34, 41, 43 and 36, 39 are closed, while the valve 29 located in the second connecting line 28 is opened. The treatment agent pump 23 is at a stop.

Since the connection between the preparation tank 22 and the tank 1 is interrupted when the valve 43 is closed, and the suction side of the recirculating pump 17 is in communication with the preparation tank outlet 24 via the connecting line 28, in this method step the treatment liquor located in the preparation tank 22 is now aspirated out of the preparation tank 22 by the recirculating pump 17 and pumped via the lines 28, 18, 21, with the valve 20 open, into the Venturi feed nozzle 6 and thus applied to the moving rope 4 of textile product. From the pressure line 21 of the recirculating pump 17, via a valve 46, a line 47 also branches off, which discharges in the tank 1 in the region of its top and makes it possible, as needed and depending on the current treatment operation, to divert additional treatment agent from the pressure line 21 and apply it directly to the rope 4 in the tank 1.

The treatment liquor dripping from the moving rope 4 during this treatment step is retained in the tank 1 and received in the sump 14 below the tank that serves as a liquor collector, so that the cuttled rope located in the reservoir 8 is no longer in contact with this collected treatment liquor.

Because the valve 43 in the suction line 16 of the recirculating pump is closed, the recirculating pump 17 and thus the rope 4 traveling through the Venturi feed nozzle 6 are constantly supplied with treatment liquor, or in other words treatment agent whose concentration stays constant, directly from the preparation tank 22. Mixing of the treatment liquor dripping from the rope 4 with the fresh treatment agent contained in the preparation tank 22 is precluded, and as a consequence there can be no changes in concentration of the treatment agent during the application to the rope 4.

The application of the treatment agent to the revolving rope 4 is regulated in treatment step 3, by means of the electronic control accomplished by the computer 44, in such a way that the treatment agent is applied uniformly to the rope in only a few revolutions of the rope. In principle, even a single revolution of the rope suffices to apply the treatment agents uniformly, such that no changes in the concentration of the applied treatment agent occur from the beginning of the rope to its end.

For the sake of uniform application of the treatment agent to the moving rope 4, the computer 44 also enters into engagement with the recirculating pump 17 and/or the regulating valve 20 in the pressure line 21 and/or the blower 11 or a throttle valve 48 of the pressure line 13. The computer 44 is programmed with a computer model that has been calculated on the basis of goods-specific and/or construction-specific and/or treatment-specific data of the rope 4 or the feed nozzle 6.

At the end of the method step, the valve 29 is closed and the valve 43 is opened, so that now the treatment liquor that has dripped from the rope and is present in the tank and sump 14 now circulates inside the machines.

After the conclusion of the method step explained in conjunction with FIG. 3, in which the treatment agent is applied to the revolving rope 4, a further method step may optionally be performed, in which further additives are introduced into the treatment agent bath in the tank 1. One example is shown in FIG. 4:

The valves 20, 46 are closed, as are the valves 41, 25, 29, 34, 31. The valve 43 located in the suction line 16 is open, as is the valve 27 located in the connecting line 26. The recirculating pump 17 can therefore pump a liquor contained in the sump (collection tank) 14 back into the preparation tank 22 via the valves 43, 27. Since the valves 20, 46 are closed, no treatment liquor that is pumped back can reach the tank 1 or the feed nozzle 6. The treatment liquor pumped back into the preparation tank 22 can now have further additional agent added to it, in order to adjust the properties and/or concentration appropriately for the next treatment step. The course of the lines via the valves 27, 42 is shown greatly exaggerated in FIG. 4.

The treatment agent located in the preparation tank 22 can be recirculated if necessary by providing that, with the valves 43, 20, 46 closed, the valves 25, 27 are opened, so that the pumps 23, 17 can pump the treatment agent in circulation via the lines 24, 26.

Once the properties and/or concentration of the treatment liquor located in the tank 22 has been readjusted for the next treatment step, the treatment liquor can again be delivered, as explained above and as shown in FIG. 3, to the machine and to the goods.

The quantity of treatment agent applied to the moving rope 4 in the feed nozzle 6 per unit of time is controlled by the computer 44 such that, as has also already been mentioned, a substantially uniform distribution of the treatment agent over the rope 4 is established. Depending on the programming of the computer 44 and on the data input by the machine operator, an optimized distribution of the treatment agent to the moving rope 4 results. The application of the treatment agent can be done over one or more revolutions of the rope.

In the novel method, the speed of revolution of the rope 4 can if necessary be varied by the computer 44 during the application of the treatment agent to the rope 4. However, it can also be kept constant.

In the exemplary embodiment described above, the treatment agent is injected into the feed nozzle 6 as described (FIG. 3) and thus applied to the rope 4. Alternatively or in addition, however, the novel method may also be performed such that the treatment agent is applied to the rope 4 upstream and/or downstream of the feed nozzle 6, in terms of the rope travel.

The treatment agent application to the rope 4, controlled by the computer 44, may also be controlled as a function of data that are definitive for the treatment agent application to the moving rope 4 and that are obtained during the course of the method. These data are processed by the computer 44 in the context of its control program in which it utilizes the computer model on which the control program is based. For that purpose, suitable sensor means are provided, which monitor the rope 4 and optionally the treatment agent.

Finally, in applying the treatment agent, the procedure with the rope 4 may also be such that the quantity of treatment agent applied to the rope is determined by suitable withdrawal of treatment agent from the preparation tank 22. This can be done for instance in such a way that in FIG. 3, the valve 29 is triggered accordingly, or that the quantity of treatment agent contained in the preparation tank 22 is dimensioned accordingly.

1. A method for uniform application of treatment agent to a textile rope in a dyeing machine, comprising:
setting the rope into revolution in a closed container by means of a Venturi feed nozzle and subjecting the rope to a gaseous feeder medium, and
exposing the rope to a liquid treatment agent, wherein
the treatment agent is stored, without contacting the rope, in a chamber separate from the rope;
the treatment agent from the chamber is made to act on the moving rope with a quantity per unit of time of treatment agent controlled as a function of time; and
the treatment agent is taken solely from the separate chamber and applied to the rope without mixing with the treatment agent draining from the rope.

2. The method as defined by claim 1, wherein treatment agent draining from the rope is caught in a collection chamber without acting on the rope.

3. The method as defined by claim 1 wherein treatment agent located in the closed container, or in a collection chamber communicating with it, is brought into the chamber that is separate from the rope.

4. The method as defined by claim 3, wherein additional agents are added to the treatment agent in the separate chamber.

5. The method as defined by claim 1 wherein the treatment agent in the separate chamber is prepared while another, separate treatment is performed on the rope is applied to the rope.

6. The method as defined by claim 1 wherein the speed of revolution of the rope and the application time of the treatment agent on the rope are adapted to one another.

7. The method as defined by claim 1 wherein the quantity per unit of time of treatment agent applied to the rope is controlled as a function of the speed of revolution of the rope.

8. The method as defined by claim 1 wherein the speed of revolution of the rope is kept constant during the application of the treatment agent to the rope.

9. The method as defined by claim 1 wherein the speed of revolution of the rope is varied during the application of the treatment agent to the rope.

10. The method as defined by claim 1 wherein upon application of the treatment agent to the rope, the volumetric flow of treatment agent is kept constant.

11. The method as defined by claim 1 wherein upon application of the treatment agent to the rope, the volumetric flow of treatment agent is varied.

12. The method as defined by claim 1 wherein the quantity of treatment agent applied to the rope is determined by suitable withdrawal of treatment agent from the separate chamber.

13. The method as defined by claim 1 wherein the quantity of treatment agent to be applied to the rope is determined by suitable addition of further treatment agent into the separate chamber.

14. An apparatus for performing the method as defined by claim 1, having a closed tank, a Venturi feed nozzle system associated with the tank and acted upon by a gaseous feeder medium, and having a device for applying a liquid treatment agent to a revolving rope made to revolve in the tank by the feed nozzle system, wherein the apparatus has a preparation tank, forming the chamber separate from the rope, and a device for feeding the treatment agent contained in the preparation tank; the preparation tank is separate or can be separated from the closed tank; and control means are provided, for causing the treatment agent from the preparation tank, without mixing with the treatment agent draining from the rope, to act on the moving rope with a quantity per unit of time of treatment agent that is controlled as a function of time.

15. The apparatus as defined by claim 14, wherein the preparation tank is joined to the closed tank via valve means, by which means the preparation tank can be separated in terms of liquid from the closed tank.

16. The apparatus as defined by claim 14 wherein pump means for the treatment agent are associated with the preparation tank and communicate via line means directly with devices for applying treatment agent to the rope in the closed tank.

17. The apparatus as defined by claim 14 wherein the preparation tank communicates with a collection chamber for receiving treatment agent drawing from the rope via line means which have at least shutoff valve means and pump means for feeding treatment agent, caught in the collection chamber, into the preparation tank.

18. The apparatus as defined by claim 17, wherein the collection chamber is embodied in a collection tank located below the closed tank.

19. The apparatus as defined by claim 15 further comprising a tank for an additional agent, which communicates with the preparation tank via line means that contain selectively triggerable valve means.
